(19) United States
(12) Patent Application Publication
(10) Pub. No.: US 2006/0212401 A1
(43) Pub. Date: Sep. 21, 2006

(54) Method and system for network-based promotion of particular digital media items

(75) Inventors: Debra Ameerally, Sunnyvale, CA (US); Thomas K. Burkholder, Vancouver (CA); Matthew David Fischer, San Francisco, CA (US); Patrice Gautier, San Francisco, CA (US); Alexander Lee Luke, Mountain View, CA (US); Christopher Laurence Bell, Pacifica, CA (US)

Correspondence Address: BEYER WEAVER & THOMAS, LLP, P.O. BOX 70250, OAKLAND, CA, 94612-0250, US

(73) Assignee: Apple Computer, Inc.

(21) Appl. No.: 11/082,207

(22) Filed: Mar. 15, 2005

(51) Int. Cl. G06Q 99/00

(52) U.S. Cl. 705/51

(57) ABSTRACT

A method of operating a digital media purchase system includes, within the digital media purchase system, receiving a unique promotional code from one of a plurality of consumers via a data network. The receipt is in association with a user account of the one consumer with the digital media purchase system. A database associated with the media purchase system is processed to determine particular digital media items associated with the received one promotional code. A user account of the one consumer with the media purchase system is configured to enable access to the determined particular digital media from the media purchase system.

### CROSS-REFERENCE TO RELATED APPLICATIONS

This application is related to co-pending patent application Ser. No. 10/688,213, entitled “METHOD AND SYSTEM FOR NETWORK-BASED ALLOWANCE CONTROL”, filed on Oct. 15, 2003, which is incorporated herein by reference in its entirety for all purposes. This application is also related to: Ser. No. 10/833,267, filed Apr. 26, 2004, and entitled “METHOD AND SYSTEM FOR NETWORK-BASED PURCHASE AND DISTRIBUTION OF MEDIA”, which is incorporated herein by reference in its entirety for all purposes.

### COPYRIGHT NOTICE

A portion of the disclosure of this patent document contains material which is subject to copyright protection. The copyright owner has no objection to the facsimile reproduction by anyone of the patent document or the patent disclosure as it appears in the U.S. Patent and Trademark Office patent file or records, but otherwise reserves all copyright rights whatsoever.

### BACKGROUND OF THE INVENTION

1. Technical Field

The present invention relates promotion relative to a digital media purchase system and, more particularly, to employing promotional codes with which particular digital media items are associated in a promotional database of a digital media purchase system.

2. Description of the Related Art

Online music stores have become popular in recent years. One very popular such online music store is the iTunes Music Store® by Apple Computer, Inc. Particularly due to its popularity, the iTunes Music Store® is a good vehicle for co-promotions. For example, the iTunes Music Store® has cooperated with Pepsi in a marketing co-promotion in which bottle caps of selected bottles of Pepsi soft drinks included a unique code redeemable via the iTunes Music Store® to download one free song.

The free song redeemable via the iTunes Music Store® is of the winner user's choosing. Furthermore, the iTunes Music Store® has offered the ability to purchase gift certificates. The recipient user of such a gift certificate enters a certificate number via the iTunes Music Store® to apply the gift certificate towards downloading songs the user's choosing.

### SUMMARY OF THE INVENTION

It is desirable in some instances to be more focused with regard to promotions and or gifts of online digital media. The present invention pertains to methods and systems to employ unique promotional codes, associated with particular digital media items.

In accordance with one aspect, a method of operating a digital media purchase system includes, within the digital media purchase system, receiving a unique promotional code from one of a plurality of consumers via a data network. The receipt is in association with a user account of the one consumer with the digital media purchase system. A database associated with the media purchase system is processed to determine particular digital media items associated with the received one promotional code. A user account of the one consumer with the media purchase system is configured to enable access to the determined particular digital media from the media purchase system.

In accordance with another aspect, one or a plurality of promotional media embodied in a tangible medium is provided. Each promotional medium includes a unique promotional code corresponding to data in a database of a digital media purchase system. The database associates the unique promotional code to at least one particular digital media item accessible, at a discount, via the digital media purchase system.

In accordance with another aspect, a method of configuring a promotion is provided. A plurality of unique promotional code are generated. A database of a digital media purchase system is populated to associate the unique promotional codes to particular digital media items accessible, at a discount, via the digital media purchase system. Populating of the database includes associating each unique promotional code with particular ones of the digital media items.

In accordance with another aspect, a digital media purchase system is configured to operate a promotion. A media commerce server is configured to interface with a client via a data network to receive a particular unique promotional code. A promotional database is configured to associate a plurality of unique promotional codes to particular ones of media held in a media store. The particular unique promotional code is one of the plurality of unique promotional codes. The media commerce server is configured to interoperate with the promotional database to determine, for the received unique promotional code, the associated particular ones of the media held in the media store and to make the determined associated particular ones of the media accessible to the client.

### BRIEF DESCRIPTION OF THE DRAWINGS

FIG. 1 is a block diagram of a system including a digital media purchase system according to one example of the invention.

FIG. 2 illustrates an example of promotional media including a promotional code for use with a digital media purchase system such as is illustrated in FIG. 1.

FIG. 3 is a flowchart illustrating a process operable using the FIG. 1 system.

FIG. 4 is a flowchart illustrating processing within an example of the digital media purchase system.

FIGS. 5-7 are screen shots illustrating, in accordance with an example, the FIG. 4 processing.

### DETAILED DESCRIPTION

Various examples are discussed herein with reference to the figures. It should be appreciated that the detailed description given herein is for explanatory purposes and the invention extends beyond these examples, as set forth in the claims.

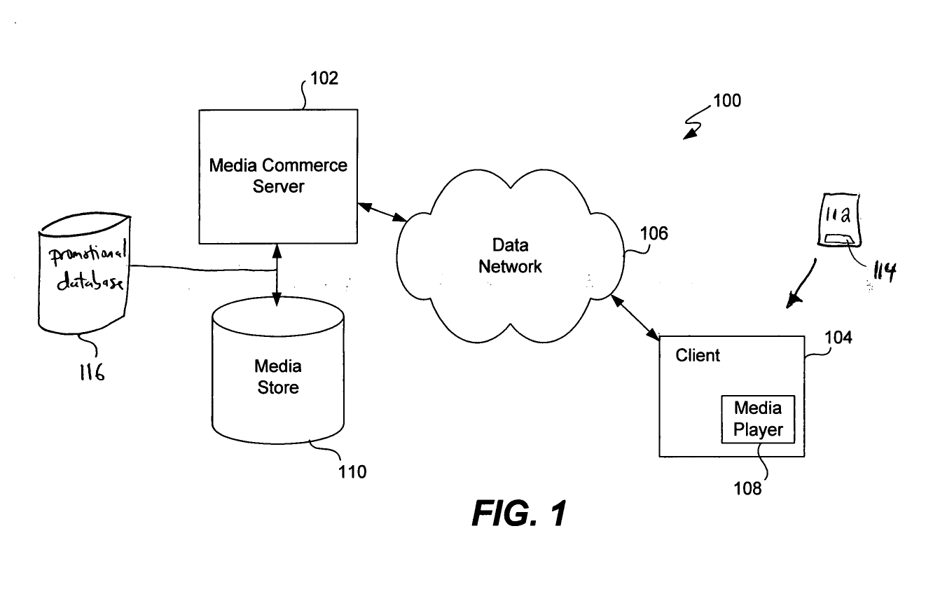

FIG. 1 is a block diagram of a system including a digital media purchase system. The digital media purchase system 100 includes a digital media commerce server 102. The digital media commerce server 102 coordinates review and/or purchase of digital media items through on-line transactions. The digital media purchase system 100 also includes a client 104. Typically, the media purchase system 100 would include a plurality of different clients 104, and each client 104 includes a digital media player 108. The digital media player 108 is an application program (e.g., specific software application, or web browser program) that operates on the client 104, which is a computing device.

The client 104 is coupled to the digital media commerce server 102 through a data network 106. Hence, any of the clients 104 can interact with the media commerce server 102 to review and receive media items. In one embodiment, the data network 106 includes at least a portion of the Internet. The clients 104 can vary with application but generally are computing devices that have memory storage. Often, the clients 104 are personal computers or other computing devices that are capable of storing and presenting digital media to their users.

The digital media purchase system 100 also includes a digital media store 110. The digital media store 10 provides mass storage of the numerous digital media items that are accessible by purchase via the media purchase system 100. The digital media items are accessed from the digital media store 110 over the data network 106 by way of the digital media commerce server 102.

More particularly, the digital media purchase system 100 allows a user of the client 104 to utilize the digital media player 108 to browse, search or sort through a plurality of digital media items that can be accessed by purchase from the media commerce server 102. The digital media player 108 may also allow the user to preview a media clip of the digital media items. In the event that the user of the digital media player 108 desires to purchase a particular media item, the user (via the media player 108) and the media commerce server 102 engage in an on-line commerce transaction in which the user pays for access rights to the particular digital media item. In one embodiment, a credit card account associated with the user is debited for the purchase amount of the particular media item.

In the digital media purchase system 100, the digital media items are stored in the digital media store 110 and retrieved via the media commerce server 102. However, a separate digital media storage server could additionally be provided and coupled between the data network 106 and the digital media store 110. The benefit of such a digital media storage server would be that the digital media commerce server 102 need not burden its resources to deliver any of the digital media items that may be purchased to the client 104.

Instead, on purchasing a particular digital media item, the digital media commerce server 102 sends download information to the digital media player 108 on the client 104. The download information can then be used by the digital media player 108 (and the client 104) to retrieve the digital media content for the particular digital media item by interacting with the digital media storage server through the data network 106. In this regard, the digital media storage server obtains the digital media content corresponding to the particular digital media item from the media store 110 and downloads such content through the data network 106 to the client 104. The downloaded digital media content can then be stored on the client 104.

In one embodiment, the downloaded digital media content is encrypted as received at the client 104 but is decrypted and then re-encrypted before persistent storage on the client 104. Thereafter, the digital media player 108 can present (e.g., play) the digital media content at the client 104. In addition, digital media search processing/browsing may be performed by an application program operating on a client. The application program is, for example, the digital media player 108 illustrated in FIG. 1.

Here, in one example, the digital media commerce server 102 illustrated in FIG. 1 can also serve as the media storage server. However, these functions may be implemented in separate servers. The search request is a request to the remote digital media server to perform a search in accordance with the search criteria for a particular song or album. Here, the digital media commerce server 102 includes at least information (e.g., metadata) for a large number of digital media items that are available to be purchased from the media commerce server 102, though the content of the media items that are purchased may be acquired at the client via download with respect to another remote server, such as the media storage server.

In addition to the components already discussed, the digital media purchase system also includes a promotional database 116. The promotional database includes data to relate unique promotional codes to promotions. By unique, it is meant that a promotional code is “used” only once. What is meant by “using” a promotional code is discussed later. Basically, however, when the promotional code is used, particular digital media content is made accessible from the digital media purchase system 100.

In some examples, such digital media content is particular digital media content that is associated in the promotional database 116 with the promotional code. In other examples, such digital media content is not directly associated with the promotional code but, rather, the promotional code is associated with only with a monetary value, leaving the choice of particular digital media to the user. The use of the term “database” is not meant to imply any particular level of sophistication.

In accordance with the FIG. 1 example, users of the client 104 may receive promotional media 112 including a unique promotional code 114. Via the client 104 and the data network 106, the unique promotional code 114 is provided to the promotional database 116, which enables the promotion associated with the unique promotional code 114.

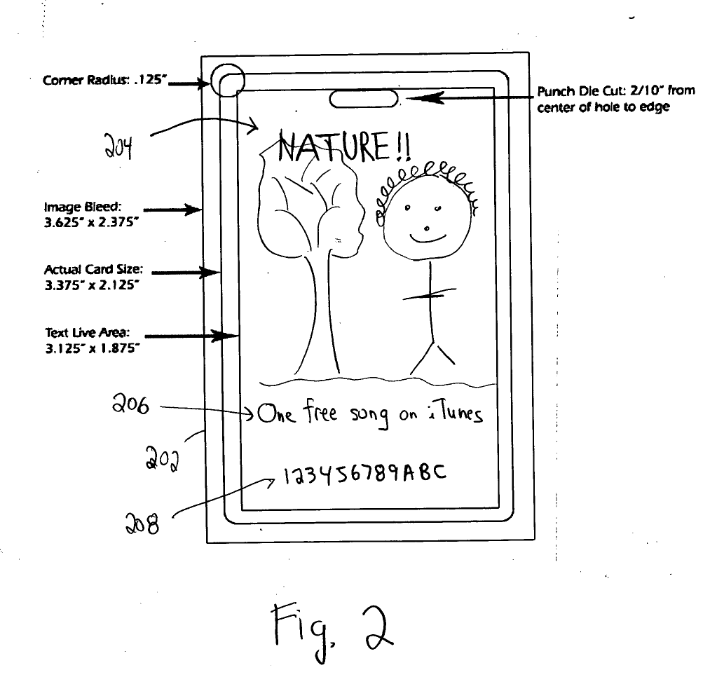

FIG. 2 shows an example of the promotional media 112 in greater detail. Referring to FIG. 2, a card-shaped promotional medium 202 is illustrated. A unique promotional code 208, associated with a promotion by the digital media purchase system 100 processing the promotional database 116, is printed on the promotional medium 202. Also printed on the promotional medium 208 is a graphic 204 illustrating the promotion with which the promotional code 208 is associated. Text 206, reciting “One free song on iTunes” describes the promotion in a human-readable format. The items are not limited to being printed on the promotional medium on just one side.

Other example types of promotional media include, but are not limited to product packaging (e.g., a bottle cap) or an article attached to product packaging (label, hang tag, etc.). Yet other examples of promotional media include e-mail messages, computer-readable media such as magnetic or optical media, graphical user interfaces of programs operable on clients 104 (FIG. 1), and web pages. In addition, the promotional codes may not be in human-readable form but, rather (or in addition), may be in computer-readable form such as bar code or other optical encoding (e.g., encoded in pits and grooves of an optically-readable media), magnetic or other computer-readable form.

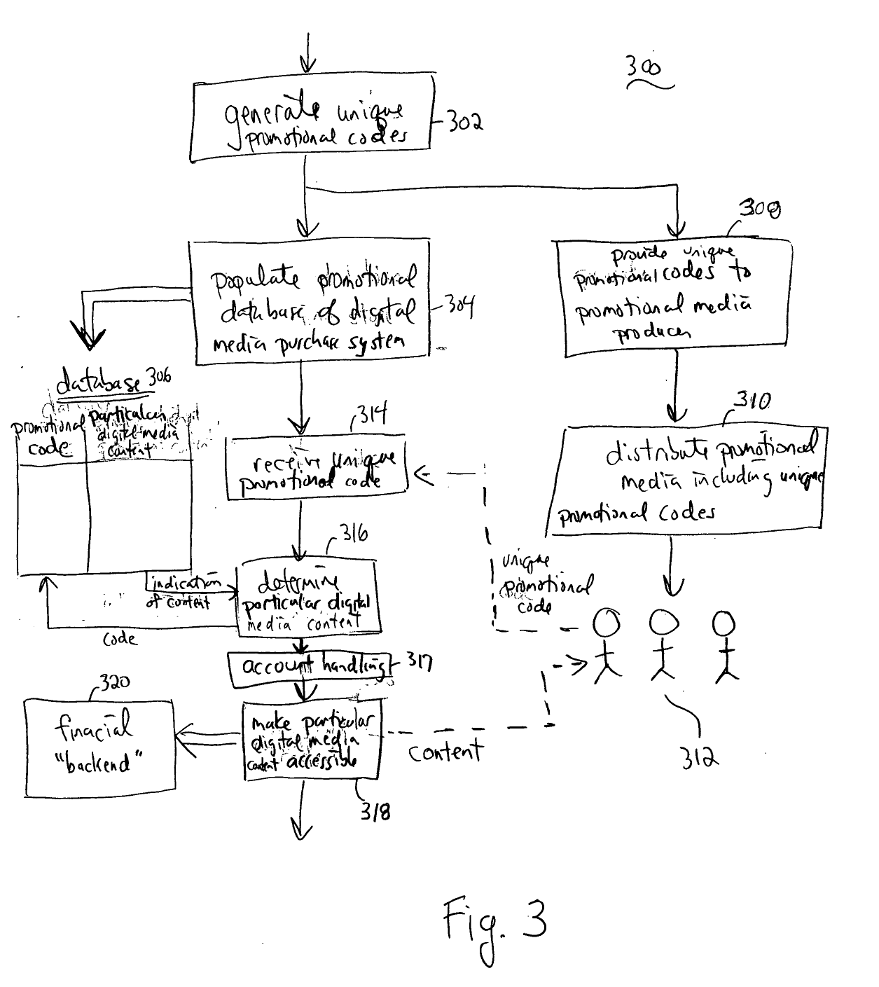

We now turn to FIG. 3, which illustrates processing 300 for operating a promotion. In the FIG. 3 processing, unique promotional codes, associated with particular digital media, are generated, received and processed to operate the promotion. At step 302, the promotional codes are generated.

The processing in step 302 occurs “offline” and not in association with the operation of a digital media purchase system 100. In one example, the promotional codes are generated to be a random string of twelve characters, where each character is chosen from a particular character set to minimize or eliminate ambiguity between characters. In addition, before a generated twelve character code is accepted as a promotional code, the string is examined to filter out strings with offensive words that may randomly occur.

At step 304, the generated promotional codes are used to populate the promotional database 306 of the digital media purchase system. The promotional database 306 is shown to only include entries that associate promotional codes (in the left column) with indications of particular digital media content (in the right column). Depending on the particular promotion, an indication of particular digital media content may be common to plural promotional codes such that, in operation of the promotion, each of those plural promotional codes would access the same particular digital media content. In typical examples, the graphic 204 on the promotional media 202 corresponds to the particular digital media content.

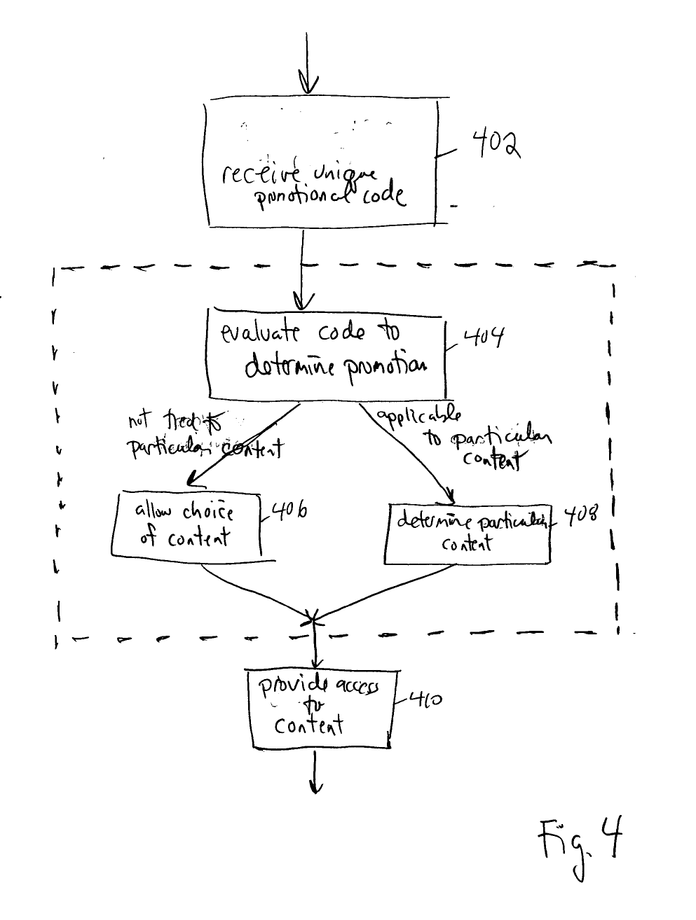

While not shown in FIG. 3, the promotional database 306 may be configured and populated to also include, for at least some promotional codes, an indication of a monetary value, leaving to the user the choice of particular digital media to purchase with the monetary value. This is the nature of the Pepsi/iTunes promotion discussed in the Background. This is discussed later, with reference to FIG. 4.

In addition, at step 308, the unique promotional codes are provided to a promotional media producer to include the unique promotional codes on promotional media such as card-shaped promotional media (FIG. 2) or other types of promotional media such as, for example, discussed above.

At step 310, in the course of the promotion, the promotional media including the unique promotional codes are distributed to consumers 312.

At step 314, the digital media purchase system 100 receives one of the unique promotional codes. Typically, as illustrated in FIG. 1, the promotional code is provided to the digital media purchase system 100 using the client 104 coupled to the digital media commerce server via the data network 106. A human user may read the promotional code and enter it via a user-interface operating on the client. In some examples, the promotional code is computer-readable and is read by the client and provided to the digital media purchase system 100.

At step 316, it is determined what is the particular digital media content associated with the received promotional code. Specifically, the database 306 is processed to determine the particular digital media content associated with the received promotional code. In a simplistic example, a table lookup is performed to index into the database 306 table using the received promotional code. The record for the received promotional code is accessed to access an indication of the particular digital media content associated with the received promotional code.

In addition, the database 306 typically includes a facility to indicate eligibility characteristics associated with the unique promotional codes. For example, some promotional codes may be eligible for use only by residents of a particular country or of particular countries. Other eligibility characteristics may include, for example, dates of validity. Furthermore, other eligibility characteristics include an indication that a unique promotional code has been cancelled for some reason not accounted for by the other eligibility characteristics. In addition, once a unique promotional code is “used,” the eligibility characteristics for the used unique promotional code are modified such that the used unique promotional code cannot be used again.

Step 317 includes processing associated with user accounts with the digital media purchase system 100. If the user is already logged in to an account with digital media purchase system 100, then processing continues at step 318. Otherwise, the user is prompted to log into an account (if the user has previously created an account) or to create an account. Most of the step 317 processing, for account handling, is part of a conventional digital media purchase system. In some examples, a user account may comprises merely the particular session in which the user is interacting with the digital media purchase system via a client, and no pre-existing and/or after-existing relationship is implied.

At step 318, the particular digital media content determined to be associated with the received promotional code is made accessible to the consumer 312. In particular, the particular digital media content is made accessible to the consumer 312 at a discount. In some examples, the discount is one hundred percent (i.e., the particular digital media content is made accessible to the consumer 312 at no cost), while in other examples, the discount is less than one hundred percent. In the examples where the discount is less than one hundred percent, the amount which the consumer 312 is required to pay is debited from the credit card account of the consumer or is otherwise accounted for using the conventional payment mechanisms of the digital media purchase system 100.

If, as the user is accessing (e.g., downloading to a client) the particular digital media content, the access is interrupted, then processing within the digital media purchase system may be executed to resume the access.

Still referring to FIG. 3, the element 320 is a financial “back end” that, perhaps among other things, tracks which particular digital media content have been made accessible to consumers, for the purpose of properly compensating rights holders in the particular digital media content, should compensation be due. In some promotions, the promotion may be operated by the rights holders themselves such as, for example, a music label causing promotional codes to be distributed to promote a new single. In other examples, the operator of the digital media purchase system handles payment of royalties (to the extent royalties are due) and may pass on these costs as appropriate to business arrangements made with a partner who “owns” the promotion.

We now turn to FIG. 4, alluded to above, which is a flow chart illustrating processing where a received unique promotional may indicate particular digital media content or may more generally indicate a promotion not tied to particular digital media content. At step 402, a unique promotional code is received. At step 404, the unique promotional code is evaluated (e.g., by processing a database such as the database 306 in FIG. 3) to determine the promotion with which the promotional code is associated. Step 406 is processing to allow the user to choose digital content for access via the digital media purchase system 100, for a promotion that is not tied to particular digital media content. Step 408 is processing to determine the particular digital media content, for a promotion that is tied to particular digital media content. Step 410 is processing to provide access to the digital media content, whether from step 406 or from step 408.

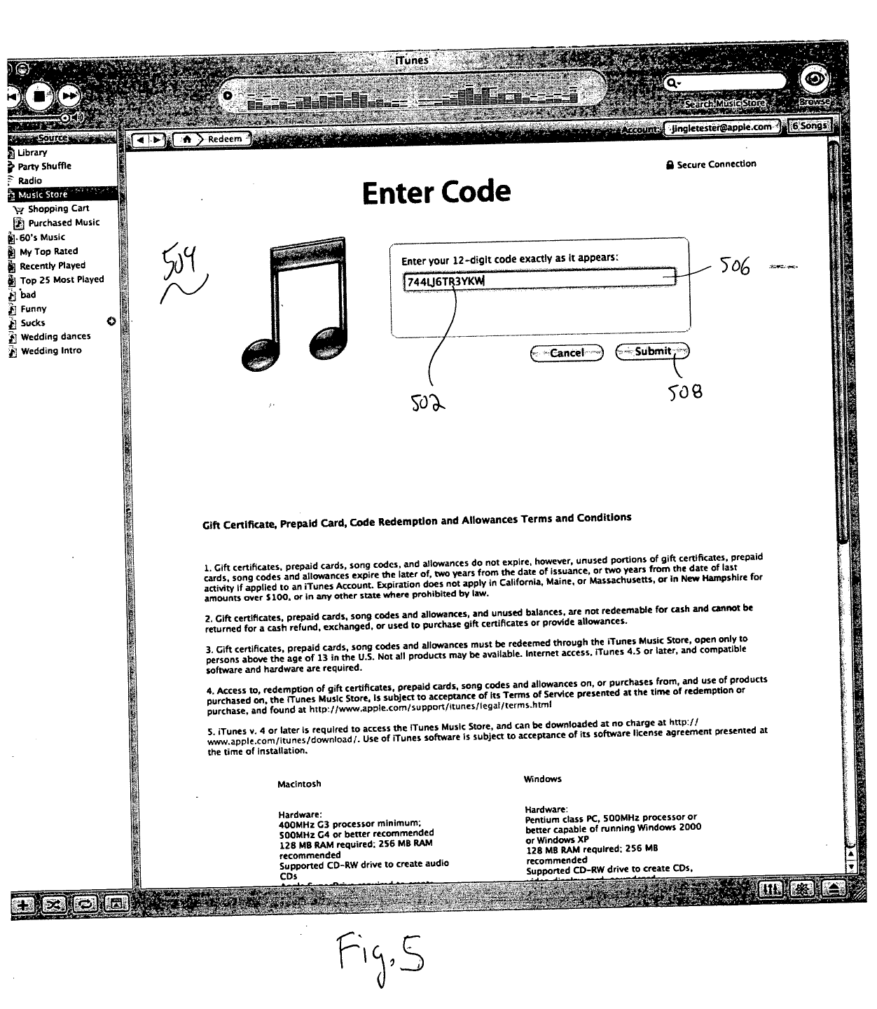

We flow turn to FIG. 5, which is a “screen shot” illustrating a particular example by which a user provides a unique promotional code 502 to the digital media purchase system 100 for the digital media purchase system to receive the unique promotional code (step 314 of the FIG. 3 flow chart). The FIG. 4 screen shot shows an example of providing the unique promotional code via an iTunes Music Store® page 504. After providing the unique promotional code 502 in a code field 506 on the page 504, the user activates the “submit” button 508 and the unique promotional code is provided to, and received by, the digital media purchase system.

In other examples, rather than the user manually entering the code via the iTunes Music Store® page or otherwise, the promotional media (e.g., an e-mail message) may contain a hypertext link that, when activated by the user, causes the unique promotional code to be automatically provided to the digital media purchase system 100.

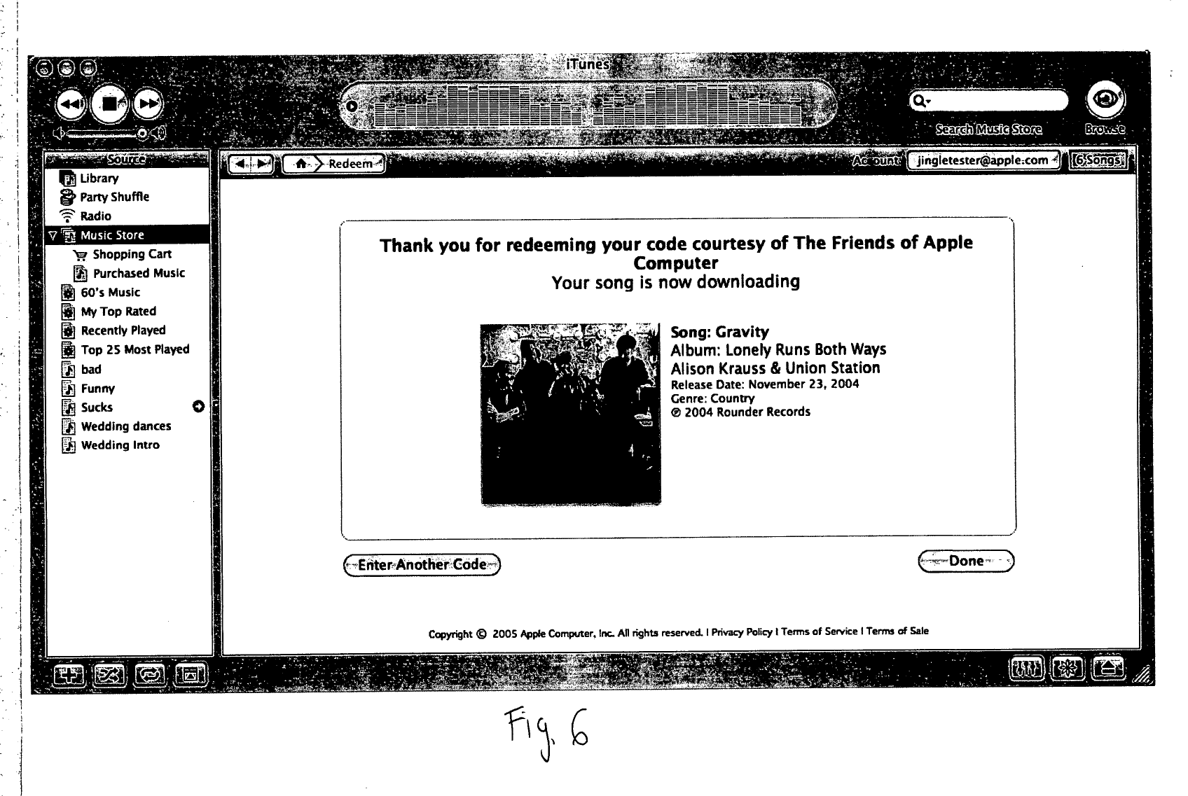

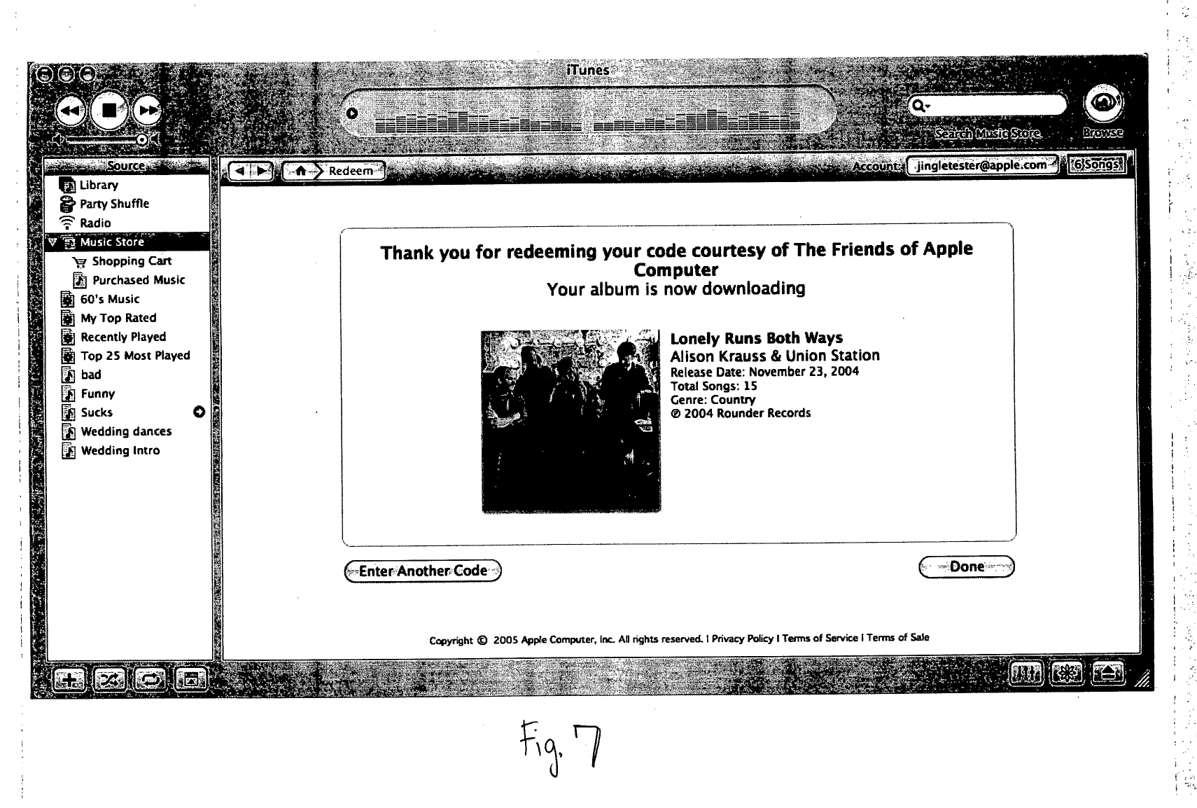

FIG. 6 is an example “screen shot” illustrating that user's account has been granted access to a particular digital item, and the particular digital item is being provided to the client. While FIG. 6 illustrates that the particular digital item is a song, FIG. 7 illustrates that the particular digital item is an album. The examples illustrated by FIG. 6 and FIG. 7 are not meant to be restrictive. The particular digital items may be, for example, audiobooks, videos, or arbitrary groupings of songs or other items.

The advantages of the invention are numerous. Different embodiments or implementations may, but need not, yield one or more of the disclosed advantages. As set forth above, one advantage of the invention is that a promotion may be set up to promote particular digital media items via a digital media purchase system. Thus, for example, a music label may utilize the digital media purchase system to promote particular digital media items. Or, for example, a party that is not a music label may make an arrangement with a music label or other rights holder to utilize, in a promotion, digital media items whose rights are owned by the rights holder.

The many features and advantages of the present invention are apparent from the written description and, thus, it is intended by the appended claims to cover all such features and advantages of the invention. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A method of operating a digital media purchase system, comprising:
receiving, at the digital media purchase system, a unique promotional code from one of a plurality of consumers via a data network, in association with a user account of the one consumer with the digital media purchase system;
processing the received promotional code at the media purchase system to determine at least one particular digital media item associated with the received promotional code; and
configuring the user account of the one consumer with the media purchase system to enable access to the determined at least one particular digital media item from the media purchase system.

2. The method of claim 1, wherein:
the step of configuring the user account to enable access includes configuring the user account to enable access to the determined at least one particular digital media item from the media purchase system at a discount.

3. The method of claim 2, wherein:
the discount is less than one hundred percent.

4. The method of claim 2, wherein:
the discount is one hundred percent.

5. The method of claim 1, further comprising:
providing the promotional codes to the plurality of consumers.

6. The method of claim 5, wherein:
the step of providing promotional codes includes providing each promotional code as part of promotional media.

7. The method of claim 6, wherein:
the promotional media for each promotional code includes a human readable indication of the at least one particular digital media item associated with that promotional code.

8. The method of claim 6, wherein:
the promotional media includes a card.

9. The method of claim 6, wherein:
the promotional media includes product packaging.

10. The method of claim 6, wherein:
the promotional media is attached to product packaging.

11. The method of claim 6, wherein the promotional media is an e-mail message.

12. The method of claim 1, wherein:
the particular digital media items include audio content.

13. The method of claim 12, wherein:
the audio content includes music

14. The method of claim 13, wherein:
the music includes at least one song.

15. The method of claim 14, wherein:
the at least one song comprises a compilation of songs.

16. The method of claim 15, wherein:
the compilation of songs comprises an album.

17. The method of claim 1, wherein:
the at least one particular digital media item includes video content.

18. The method of claim 1, further comprising:
processing the received promotional code in view of characteristics associated with the user account to determine if the user account is eligible to use the promotional code; and
if it is determined that the user account is not eligible to use the promotional code, not performing the user account configuring step with respect to the promotional code.

19. The method of claim 18, wherein:
processing the received promotional code in view of characteristics associated with the user account to determine if the user account is eligible to use the code includes comparing a jurisdiction of residence associated with the user account with jurisdictional characteristics associated with the promotional code.

20. The method of claim 1, further comprising:
within the media purchase system, prompting the one consumer to log on to the user account of the one consumer with the media purchase system.

21. The method of claim 20, further comprising:
prompting the one consumer to create a user account with the media purchase system.

22. The method of claim 6, wherein
the promotional code is included in the promotional media in association with a URL readable by a browser program.

23. The method of claim 1, further comprising:
providing the at least one determined particular digital media item from the media purchase system.

24. The method of claim 23, wherein:
the step of providing the at least one determined particular digital media items includes providing the determined at least one determined digital media item from the media purchase system to a client device, via a data network.

25. A promotional medium embodied in a tangible medium, the promotional medium including a unique promotional code corresponding to data in a digital media purchase system associating the unique promotional code to at least one particular digital media item accessible, at a discount, via the digital media purchase system.

26. A plurality of promotional media as set forth in claim 25.

27. The promotional medium of claim 25, wherein the unique promotional code is embodied in the tangible medium in a computer-readable form, wherein the promotional medium further includes code to

28. A method of configuring a promotion, comprising:
generating a plurality of unique promotional codes; and
populating a database of a digital media purchase system to associate the unique promotional codes to particular digital media items accessible, at a discount, via the digital media purchase system.

29. The method of claim 27, wherein:
the database populating step includes associating each unique promotional code with particular ones of the digital media items.

30. A digital media purchase system configured to operate a promotion, comprising:
a media commerce server configured to interface with a client via a data network to receive a particular unique promotional code; and
a promotional database, the promotional database configured to associate a plurality of unique promotional codes to particular ones of media held in a media store, wherein the particular unique promotional code is one of the plurality of unique promotional codes,
wherein the media commerce server is configured to interoperate with the promotional database to determine, for the received unique promotional code, the associated particular ones of the media held in the media store and to make the determined associated particular ones of the media accessible to the client.

31. A method of operating a promotion, comprising:
providing a plurality of promotional media, each promotional medium including a unique promotional code corresponding to data in a digital media purchase system associating that unique promotional code to at least one particular digital media item accessible, at a discount, via the digital media purchase system.

32. A computer-readable medium, comprising:
a tangible medium having embodied therein a unique computer-readable promotional code, the unique promotional code usable by a computer system to associate that unique promotional code with at least one particular digital media item and to make the at least one particular digital media item accessible, at a discount, via the digital media purchase system.
